(19) United States
(12) Patent Application Publication
(10) Pub. No.: US 2010/0030733 A1
(43) Pub. Date: Feb. 4, 2010

(54) Transforming SQL Queries with Table Subqueries

(76) Inventor: Alphonza Draughn, JR., (US)

Correspondence Address: Alphonza Draughn JR., 945 Persimmon Point, Atlanta, GA, 30328, US

(21) Appl. No.: 12/184,478

(22) Filed: Aug. 1, 2008

(51) Int. Cl. G06F 17/30

(52) U.S. Cl. 707/2; 707/E17.017

(57) ABSTRACT

A computer automated technique for rewriting SQL with table subqueries into more optimal table expression equivalents without derived tables. The context of the table subqueries, including any join and filter predicates are moved to the encompassing outer query. The advantage of this technique is to provide optimized source SQL to the relational database optimizers.

### FIELD OF THE INVENTION

This invention relates generally to relational databases, and more particularly to rewriting source SQL with Table Subqueries.

### BACKGROUND OF THE INVENTION

A relational database management system (RDBMS) is a database management system (DBMS) that is based on the relational model. At a minimum, these systems present data to the user as relations (a presentation in tabular form, i.e. as a collection of tables with each table consisting of a set of rows and columns) and provide relational operators to manipulate the data in tabular form.

Structured Query Language (SQL) is the most popular computer language used to create, modify and retrieve data from relational database management systems. The language has evolved beyond its original purpose to support object-relational database management systems. It is an ANSI/ISO standard. A standard definition of the SQL database query language is the ISO 9075 standard. SQL as defined in the ISO 9075 and in the SQL3 standard supports table subqueries (referred to as “nested table expression” or “query table expression” by some vendors).

A table subquery is a subquery in the FROM clause and returns a table of one or more rows of one of more columns. A table subquery has the advantage of acting like a permanent table but is not actually defined as a permanent table.

However, database engines determine access plans based on the permanent base tables and often produce less efficient access plans (steps to retrieve the data from base tables) when table subqueries are used because of the extra layer of abstraction from the base tables. Often a Temporary table is created to satisfy the table subquery. This temporary table creation and access process can be eliminated if the query were transformed into its base table equivalent before being seen by database engine optimizer.

It is therefore desirable to provide a computer-implemented method for transforming SQL with table subqueries into joins against the base tables before optimization to allow more efficient access paths to be generated by the database optimizers.

### SUMMARY OF THE INVENTION

According to an aspect of the invention, an improved computer-implemented method of SQL table subquery transformation is provided. The method involves removing the nested table expression and replacing it with a logically equivalent join of the base tables.

### BRIEF DESCRIPTION OF THE DRAWINGS

In drawings which illustrate by way of example only a preferred embodiment of the invention,

FIG. 1 is a flow-chart showing the high-level logic of the computer-implemented method of the preferred embodiment.

### DETAILED DESCRIPTION OF THE INVENTION

The preferred embodiment of the invention is a computer-implemented method (implemented in a computer program product) to transform SQL queries with Table Subqueries or derived tables into logically equivalent SQL queries using Joined tables.

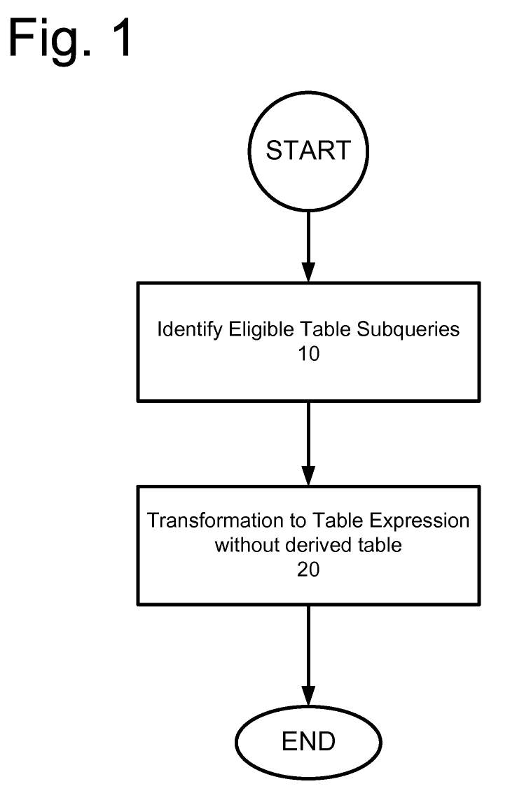

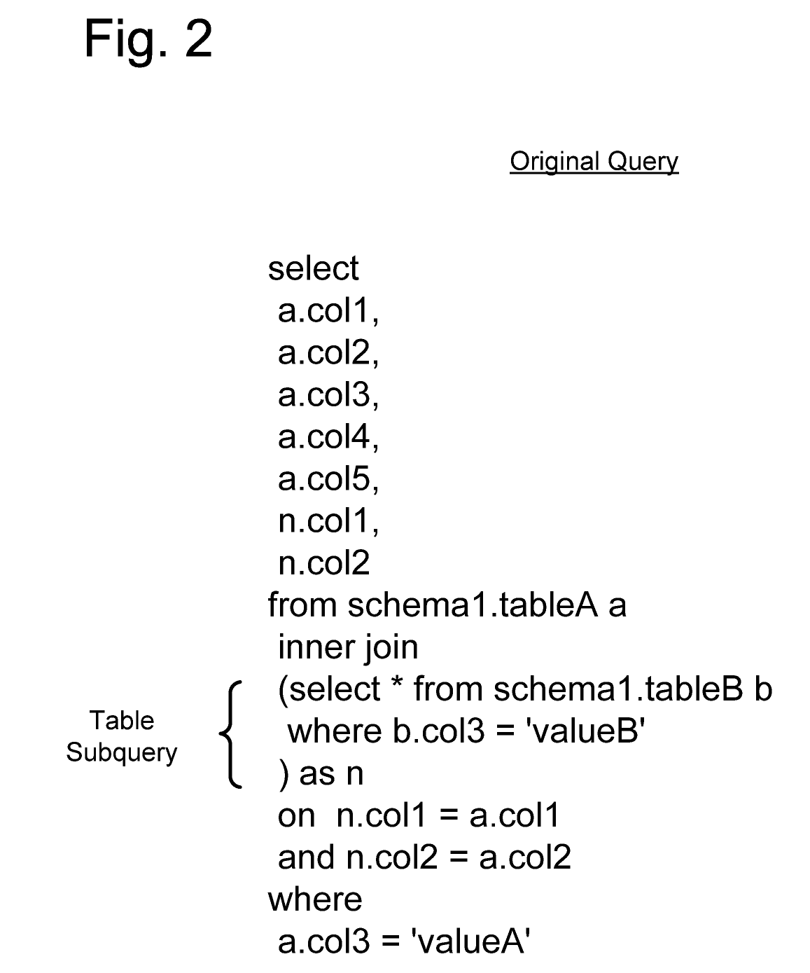

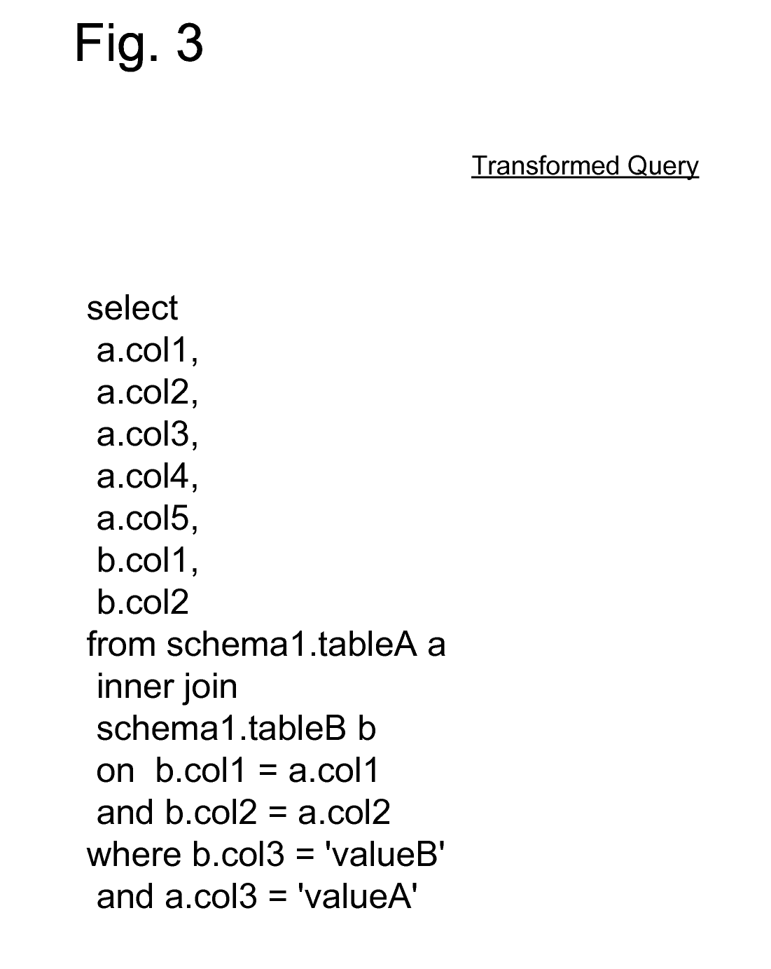

FIG. 1 is a flowchart showing a high-level description of the method of the preferred embodiment. As will be apparent from the following description, the steps of boxes 10, 20 are each iterative processes. Box 10 represents the first step in the transformation process. Here, the Table Subquery is identified (within the topmost FROM clause of this potentially nested structure). Determining the eligibility of a table subquery for transformation is accomplished by searching within the table subquery for the existence of a GROUP BY clause or any of following Aggregate or Regression functions: AVG, CORRELATION, COUNT, COUNT_BIG, COVARIANCE, GROUPING, MAX, MIN, STDDEV, SUM, and VARIANCE.

FIG. 2 is shows an example of an eligible table subquery within an original SQL Query before transformation.

The next step in the transformation process is represented as Box 20 in FIG. 1. In this step the table subquery is removed and replaced with a logically equivalent table expression with no intervening derived table. This is accomplished by moving all of the Where Clause search conditions from each eligible table subquery to the Where clause of the outer encompassing Query, along with preserving the application of specified logical operators to the result of each predicate. In-addition, moving all of the From Clause table expressions from the table subquery to the From Clause of the outer encompassing Query, preserving the application of specified logical operators to the result of each Join condition. If a Correlation name is associated with the table subquery, it is replaced with original table subquery “From clause” Correlation names if used in the Select clause, search or Join conditions in the outer query.

FIG. 3 shows the completed transformation of the FIG. 2 example after the identified eligible table subquery is removed and the Original Query is rewritten as a logically equivalent Join without any derived tables.

The preferred embodiment of the invention as described in detail by way of example, it will be apparent to those skilled in the art that variations and modifications may be made without departing from the invention. The invention includes all such variations and modifications that fall within the scope of the appended claims.

What is claimed is:

1. A method for rewriting a SQL query statement by moving all of the Where Clause search conditions from each eligible table subquery to the Where clause of the outer encompassing Query, preserving the application of specified logical operators to the result of each predicate.

2. The method of claim 1, after rewriting a SQL query statement by moving all of the Where Clause search conditions from each eligible table subquery to the Where clause of the outer encompassing Query, preserving the application of specified logical operators to the result of each predicate, of rewriting the query without reference to the table subquery.

3. The method of claim 1, wherein if removal of the table subquery by rewriting the SQL Query statement would change the number of rows produced by the resulting query statement, rewriting the SQL query statement is not performed.

4. The method of claim 1 further comprising moving all of the From Clause table expressions from the table subquery to the From Clause of the outer encompassing Query, preserving the application of specified logical operators to the result of each Join condition.

5. The method of claim 4, wherein a Correlation name is associated with the table subquery comprising replacing the table subquery Correlation name with original table subquery “From clause” Correlation names if used in the Select clause, search or Join conditions in the outer query.

6. The method of claim 4, further comprising removing the remaining parenthesis of an empty table subquery.

7. The method of claim 1 performed on a computer.

8. A computer program, stored on a tangible medium, for use in rewriting a SQL query statement, the program comprising executable instructions that cause a computer to move all of the Where Clause search conditions from each eligible table subquery to the Where clause of the outer encompassing Query, preserving the application of specified logical operators to the result of each predicate.

9. The computer program of claim 8, configured to perform a step, after the step of rewriting a SQL query statement by moving all of the Where Clause search conditions from each eligible table subquery to the Where clause of the outer encompassing Query, preserving the application of specified logical operators to the result of each predicate, of rewriting the query without reference to the table subquery.

10. The computer program of claim 8, wherein if removal of the table subquery by rewriting the SQL Query statement would change the number of rows produced by the resulting query statement, rewriting the SQL query statement is not performed.

11. The computer program of claim 8, further comprising moving all of the From Clause table expressions from the table subquery to the From Clause of the outer encompassing Query, preserving the application of specified logical operators to the result of each Join condition.

12. The computer program of claim 11, wherein a Correlation name is associated with the table subquery comprising replacing the table subquery Correlation name with original table subquery “From clause” Correlation names if used in the Select clause, search or Join conditions in the outer query.

13. The computer program of claim 11, further comprising removing the remaining parenthesis of an empty table subquery.

14. A method for rewriting a SQL query statement by moving all of the Where Clause search conditions from each eligible table subquery to the Where clause of the outer encompassing Query, preserving the application of specified logical operators to the result of each predicate prior to running the query.
